(19) United States
(12) Patent Application Publication
(10) Pub. No.: US 2010/0105219 A1
(43) Pub. Date: Apr. 29, 2010

(54) BOARD-TO-BOARD CONNECTOR AND ARRANGEMENT WITH TWO CIRCUIT BOARDS

(75) Inventors: Pauli Havukainen, Ylamylly (FI); Tarmo Karhapaa, Joensuu (FI)

Correspondence Address: YOUNG & THOMPSON, 209 Madison Street, Suite 500, Alexandria, VA, 22314, US

(73) Assignee: PERLOS OYJ, VANTAA (FI)

(21) Appl. No.: 12/446,290

(22) PCT Filed: Oct. 19, 2007
(86) PCT No.: PCT/FI07/50566

§ 371 Date: Sep. 24, 2009

(30) Foreign Application Priority Data
Oct. 20, 2006 (FI) 20065670

(51) Int. Cl. H01R 12/00

(52) U.S. Cl. 439/66

(57) ABSTRACT

A board-to-board connector and an arrangement with two circuit boards. A body of the connector is provided with one or more electrically conductive contacts. Such a contact includes a soldering surface for the contact to be attached to a conductive pattern of a first circuit board. The contact further includes a contact surface to be arranged in contact with the conductive pattern of a second circuit board. The second circuit board is arranged at a distance from the first circuit board and substantially parallel therewith. The contact still further includes a spring part arranged between the soldering surface and the contact surface. The contact surface is in immediate contact with a part of the conductive pattern on the surface of the second circuit board and the spring part allows resilience between the soldering surface and the contact surface in a perpendicular direction with respect to a plane of the soldering surface.

### BACKGROUND OF THE INVENTION

The invention relates to a board-to-board connector comprising means for interconnecting conductive patterns of two circuit boards, the connector having a body, the body being provided with one or more electrically conductive contacts, such a contact comprising a soldering surface for the contact to be attached to the conductive pattern of a first circuit board; the contact further comprising a contact surface to be arranged in contact with the conductive pattern of a second circuit board arranged at a distance from the first circuit board and substantially parallel thereto, and the contact still further comprising a spring part arranged between the soldering surface and the contact surface.

The invention further relates to an arrangement with two circuit boards, the arrangement comprising two circuit boards arranged side by side and substantially parallel, at least one board-to-board connector arranged in a space provided between the circuit boards and comprising means for interconnecting conductive patterns of the circuit boards, the connector having a body being provided with one or more electrically conductive contacts, such a contact comprising a soldering surface by which the contact is connected to the conductive pattern of a first circuit board, the contact further comprising a contact surface arranged in contact with the conductive pattern of a second circuit board, and a spring part arranged between the soldering surface and the contact surface.

As is well known, a board-to-board connector electrically interconnects two circuit boards. Presently, a technique called SMT (Surface Mounted Technology) is generally used for the circuit boards of mobile telephones and other corresponding small portable electronic devices. Herein, components to be attached to a circuit board are soldered to the surface of the circuit board rather than into through-holes provided in the circuit board. Board-to-board connectors are used in various types of electronic devices, but particularly in portable devices containing electronics, such as portable computers and products called hand-held devices, e.g. mobile telephones and the like.

In hand-held devices in particular, an ongoing trend is to strive for less space-consuming solutions. Board-to-board connectors are an important factor defining the need for space, since their dimensions—height mainly—determine the minimum distance between circuit boards. The existing board-to-board connectors do not completely meet the ever tightening demands for space.

### BRIEF DESCRIPTION OF THE INVENTION

An object of the present invention is to provide a novel and improved board-to-board connector and an arrangement with two circuit boards.

A board-to-board connector according to the invention is characterized in that the contact surface is in immediate contact with a part of the conductive pattern on the surface of the second circuit board, and that the spring part allows resilience between the soldering surface and the contact surface with respect to the plane of the soldering surface in a perpendicular direction.

An arrangement with two circuit boards according to the invention is characterized in that the contact surface is in immediate contact with a part of the conductive pattern on the surface of the second circuit board, and that the spring part allows resilience between the soldering surface and the contact surface with respect to the first circuit board in a perpendicular direction.

The idea underlying the invention is that the contact surface of the contact is in direct contact with a part of the conductive pattern provided on the surface of the second circuit board, and that the contact is resilient in a direction of the height of the space provided between the circuit boards.

An advantage of the invention is that the structure of the connector is low, which enables the circuit boards to be arranged closer to one another, enhancing the utilization of space. A further advantage is that in its resilient movement, the contact may utilize the height of the space provided between the circuit boards, which enables the spring part of the connector to be provided with a sufficient resilient bend and a sufficiently large spring constant.

An idea of an embodiment of the invention is that the body is dimensioned in its lateral direction so as to enable two connectors to be arranged side by side such that the distribution of the contacts is constant across the entire width of the connectors. In such a case, by a connector comprising e.g. ten contacts, a row of connectors with 10, 20, 30, 40, 50, etc. terminals wherein the distribution of contacts remains the same across the entire width of the connector row may be provided. The advantage is that by one connector width, as in the above-disclosed example by a connector with ten terminals, connector rows of different widths may be provided, instead of having to provide a separate connector for each connector width. This, among other things, reduces the need to manufacture connectors of different widths and decreases logistics costs relating to the handling of connectors.

An idea of another embodiment of the invention is that the contact surface has a substantially curved shape in profile. An advantage is that small variations in the distances between the circuit boards, which may be produced e.g. by manufacturing tolerances, do not cause any changes in the contact surface area between a contact and the second circuit board.

### BRIEF DESCRIPTION OF THE DRAWINGS

Some embodiments of the invention are described in closer detail in the accompanying drawings, in which

FIG. 1a is a schematic perspective view of a connector according to the invention as seen from a top surface,

FIG. 1b is a partly sectional schematic side view of the connector of FIG. 1a,

FIG. 1c is a schematic top view of the connector of FIG. 1a, and

FIG. 2 is a partly sectional schematic side view of the connector of FIG. 1a in an arrangement according to the invention.

For the sake of clarity, the figures show some embodiments of the invention in a simplified manner. In the figures, like reference numbers identify like elements.

### DETAILED DESCRIPTION OF SOME EMBODIMENTS OF THE INVENTION

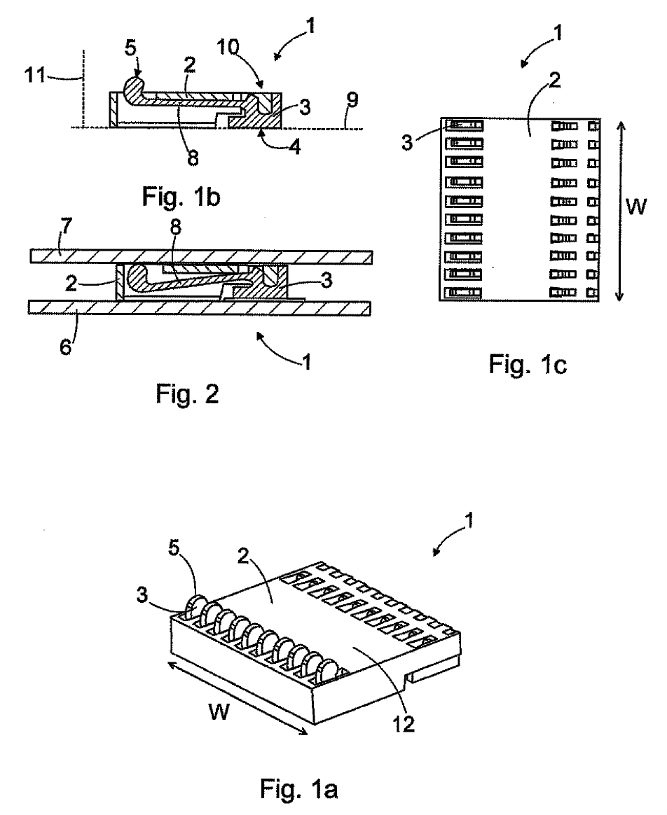

FIG. 1a is a schematic perspective view of a connector according to the invention as seen from a top surface, FIG. 1b is a partly sectional side view thereof, and FIG. 1c is a top view thereof.

A connector 1 is provided with ten contacts 3 arranged in a body 2. Naturally, the connector 1 may also be provided with another number of contacts 3.

As seen in FIG. 1c in particular, the contact density of the connector 1, i.e. the number of contacts 3 per a unit of width of the connector, is very high. This is mainly because the contacts 3 are very narrow. In this case, the contacts 3 are provided by detaching from a metal plate a part having the shape of a contact, which is either directly ready to be arranged in the connector 1 or which may be finished prior to being arranged in the connector 1. Such detachment may be carried out e.g. by an appropriately designed die. The contact 3 is dimensionally extremely accurate. In addition, an advantage of the contact 3 is that its mechanical properties, such as the spring force of a spring part 8, may be adjusted very accurately by changing the shape of a preform to be detached from the metal plate 1.

The contact 3 comprises a soldering surface 4, a contact surface 5, and a spring part 8. The soldering surface 4 and the contact surface 5 are provided on a detachment surface 2 of the contact 3, in other words on a surface being formed when the contact 3 is detached from the metal plate 1.

The contact 3 is attached to the conductive pattern of a circuit board by its soldering surface 4, which is co-directional with a plane 9 of the soldering surface. If necessary, the soldering surface 4 may be coated prior to soldering e.g. by a coating layer comprising tin and nickel.

The contact 3 is connected with the conductive pattern of a second circuit board via the contact surface 5. The contact surface 5 may be finished e.g. by coating it with a coating layer containing nickel and gold.

The spring part 8 is provided between the soldering surface 4 and the contact surface 5. The spring part 8 is resiliently flexible. The spring part 8 may be bent with respect to the plane 9 of the soldering surface in a perpendicular direction 11 away from its free resting position, and when the bending force is removed, the spring part 8 returns substantially back to its resting position.

Pressed by the spring part 8, the contact surface 5 remains attached to a mating surface belonging to a conductive pattern provided in a second circuit board 7. The contact 3 has thus not been attached to the second circuit board 7.

Preferably, the soldering surface 4 is arranged underneath the connector 1, which contributes to reducing the outer dimensions of the connector 1.

The connector 1 comprises a body 2, typically made of plastic. The contact 3 becomes attached to the body by pressing nails 10 provided in the contact 3 into the material of the body 2. Naturally, the contact 3 may also be attached to the body 2 otherwise.

Two or more connectors 1 may be installed side by side onto the circuit board. In its width direction W, the body 2 of the connector is dimensioned such that in interconnected connectors 1, a distance between the outermost contact 3 of a first connector and the nearest outermost contact 3 of a next connector equals a distance between adjacent contacts belonging to the same connector. The distribution of the contacts thus remains the same across the entire width of the interconnected connectors.

The body 2, preferably on the top surface thereof, as well as around the soldering surface 4, is provided with openings through which hot air being used in a soldering process is allowed to circulate through the body 2. This accelerates heating of the soldering surface 4 and its mating surface to a soldering temperature.

The body 2 preferably includes shapes or elements for an automatic assembly machine to grip in order to move the connector 1 to a correct spot on the circuit board. In the embodiment of the connector shown in the figures, the top surface of the body 2 is provided with a grip area 12 for the assembly machine to grip by its suction pad.

FIG. 2 is a partly sectional schematic side view of the connector of FIGS. 1a to 1c in an arrangement according to the invention. The connector 1 is attached to a first circuit board 6 by soldering the soldering surfaces 4 of the contacts 3 to the necessary conductive patterns of the first circuit board 6.

The second circuit board 7 is arranged substantially parallel with respect to the first circuit board 6. Pressed by the spring parts 8, the contact surfaces 5 of the contacts 3 are attached to the conductive pattern of the second circuit board 7. The contact surface 5 has a substantially circular shape in profile. A circular or another substantially curved shape of the contact surface 5 is preferable since in such a case, changes in the bending angle of the spring part 8 do not change the contact surface area of the contact surface 5 on the second circuit board 7. It is to be noted, however, that the contact surface 5 does not necessarily have to be curved.

In the embodiment of the connector 1 shown in the figure, the height of the body 2 is substantially equal to that of the space provided between the circuit boards 6, 7. The body 2 may be utilized as a mechanical support structure between the circuit boards to protect other components arranged between the circuit boards 6 and 7.

The contacts 3 are bent substantially completely in to the body 2. A certain air gap is then provided between adjacent contacts 3, which reduces interference between the contacts 3. At the same time, the body 2 protects the contacts 3 against mechanical damage that might otherwise occur, e.g. when a mobile telephone containing such an arrangement falls down.

The conductive pattern of the second circuit board 7 and the mating surface are manufactured in a manner known per se e.g. by removing any unnecessary electrically conductive material from the surface of the circuit board by etching or in another corresponding manner. The conductive pattern may also be deposited onto an insulating layer, or it may be manufactured in a separate process and transferred onto the surface of the insulating layer. The conductive pattern of the first circuit board 6 is also manufactured in a manner known per se, so this is not discussed in further detail in this description.

In addition to the first and the second circuit boards 6 and 7, an electronic device may of course also include other circuit boards. Some of these other circuit boards may be arranged substantially parallel and on top of one another with respect to the first and the second circuit board, and one or even more connectors 1 according to the invention may be arranged between the first and/or the second circuit board 6, 7.

In some cases the features disclosed in the present application may be used as such, irrespective of other features. On the other hand, when necessary, the features set forth in the present application may be combined in order to provide different combinations.

1-8. (canceled)

9. A board-to-board connector comprising means for interconnecting conductive patterns of two circuit boards, the connector having a body,
the body being provided with a plurality of electrically conductive contacts, such a contact comprising a soldering surface for the contact to be attached to the conductive pattern of a first circuit board, the contact further comprising
a contact surface to be arranged in contact with the conductive pattern of a second circuit board arranged at a distance from the first circuit board and substantially parallel therewith, and
the contact still further comprising a spring part arranged between the soldering surface and the contact surface,
the contact surface being in immediate contact with a part of the conductive pattern on the surface of the second circuit board,
the spring part allowing resilience between the soldering surface and the contact surface with respect to a plane of the soldering surface in a perpendicular direction, wherein the body is dimensioned in a lateral direction such that at least two connectors are arrangeable side by side such that a distribution of the contacts is constant across the entire width of a row of connectors formed by the connectors.

10. A connector as claimed in claim 9, wherein the spring part being in an unloaded state, the contact surface resides outside extreme surfaces of the body, and that the spring part is bendable so that the contact resides substantially inside the extreme surfaces of the body.

11. A connector as claimed in claim 9, wherein the contact surface has a substantially curved shape in profile.

12. A connector as claimed in claim 9, wherein the contact comprises attachment teeth to attach the contact to the body.

13. An arrangement with two circuit boards, the arrangement comprising two circuit boards arranged side by side and substantially parallel, at least one board-to-board connector arranged in a space provided between the circuit boards and comprising means for interconnecting the conductive patterns of the circuit boards, the connector having
a body being provided with a plurality of electrically conductive contacts, such a contact comprising a soldering surface by which the contact is attached to the conductive pattern of a first circuit board, the contact further comprising
a contact surface arranged in contact with the conductive pattern of a second circuit board, and
a spring part arranged between the soldering surface and the contact surface,
the contact surface being in immediate contact with a part of the conductive pattern on the surface of the second circuit board,
the spring part allowing resilience between the soldering surface and the contact surface with respect to the first circuit board in a perpendicular direction, wherein the body is dimensioned in a lateral direction such that at least two connectors are arrangeable side by side such that a distribution of the contacts is constant across the entire width of a row of connectors formed by the connectors.

14. An arrangement as claimed in claim 13, wherein when the spring part is in an unloaded state, the contact surface resides outside extreme surfaces of the body, and that the spring part is bendable so that the contact resides substantially inside the extreme surfaces of the body.

15. An arrangement as claimed in claim 13, wherein the height of the body substantially equals the height of the space provided between the circuit boards.

16. An arrangement as claimed in claim 13, wherein the contact surface is arranged detachably in contact with the second circuit board, and that the spring part is arranged to press the contact surface against the second circuit board.
